(19) United States
(12) Patent Application Publication
(10) Pub. No.: US 2024/0315201 A1
(43) Pub. Date: Sep. 26, 2024

(54) GYROSCOPIC PET TOY

(71) Applicant: Doskocil Manufacturing Company, Inc., Arlington, TX (US)

(72) Inventors: Josiah WILHELM, Arlington, TX (US); Ron BAGLEY, Arlington, TX (US)

(21) Appl. No.: 18/124,375

(22) Filed: Mar. 21, 2023

(51) Int. Cl. A01K 15/02; F16M 11/12

(52) U.S. Cl. CPC A01K 15/025; F16M 11/123

(57) ABSTRACT

A gyroscopic pet toy having a transparent sphere, a base member, a first magnet, an arm and a winged figure. The base member has central area and an outer edge area. The first magnet is installed to the base member proximate the central area. The arm is attached to the base member proximate a portion of the outer edge area. The arm extends upwardly over the central area of the base member. The winged figure hangs downwardly from a string-like element attached to a distal end of the arm. The winged figure is located above and spaced apart from the central area of the base member. The winged figure has a second magnet disposed therein with the first and second magnets being oriented to interact with one another. The base member, the first magnet, the arm and the winged figure are all moveably installed within the transparent sphere.

### BACKGROUND

### Technical Field

The present disclosure generally relates to a gyroscopic pet toy. More specifically, the present disclosure relates to gyroscopic pet toy that includes a base member with an upwardly extending arm having a winged figure extending therefrom, the base having a first magnet and the winged figure having a second magnet that interact with one another, the base, the arm and the winged figure all being rotatably confined within a transparent globe.

### Background Information

Pet owners are continuously seeking toys that will entertain their pets.

### SUMMARY

It has been discovered that putting a structure that remains upright within a sphere while the sphere is rolling on the floor and where a winged figure within the sphere is moved by repelling magnets can provide entertainment for a pet.

In view of the state of the known technology, one aspect of the present disclosure is to provide a gyroscopic pet toy with a base member, a first magnet, an arm and a winged figure. The base member has central area and an outer edge area. The first magnet is installed to the base member proximate the central area. The arm is attached to the base member proximate a portion of the outer edge area. The arm extends upwardly over the central area of the base member. The winged figure hangs downwardly from a string-like element attached to a distal end of the arm, the winged figure being located above and spaced apart from the central area of the base member. The winged figure has a second magnet disposed therein with the first and second magnets being oriented to interact with one another.

### BRIEF DESCRIPTION OF THE DRAWINGS

Referring now to the attached drawings which form a part of this original disclosure:

FIG. 1 is a perspective view of view of a gyroscopic pet toy disposed within a transparent sphere, the toy having a base, a curved arm and a winged figure suspended from the curved arm above a central area of the base in accordance with an exemplary embodiment;

FIG. 2 is a top view of the gyroscopic pet toy showing the base, the arm and the winged figure disposed within the transparent sphere in accordance with the exemplary embodiment;

FIG. 3 is a first side view of the gyroscopic pet toy showing the base, the arm and the winged figure disposed within the transparent sphere in accordance with the exemplary embodiment;

FIG. 4 is a second side view of the gyroscopic pet toy showing the base, the arm and the winged figure disposed within the transparent sphere in accordance with the exemplary embodiment;

FIG. 5 is a perspective view of the gyroscopic pet toy showing the base, the arm and the winged figure without the transparent sphere in accordance with the exemplary embodiment;

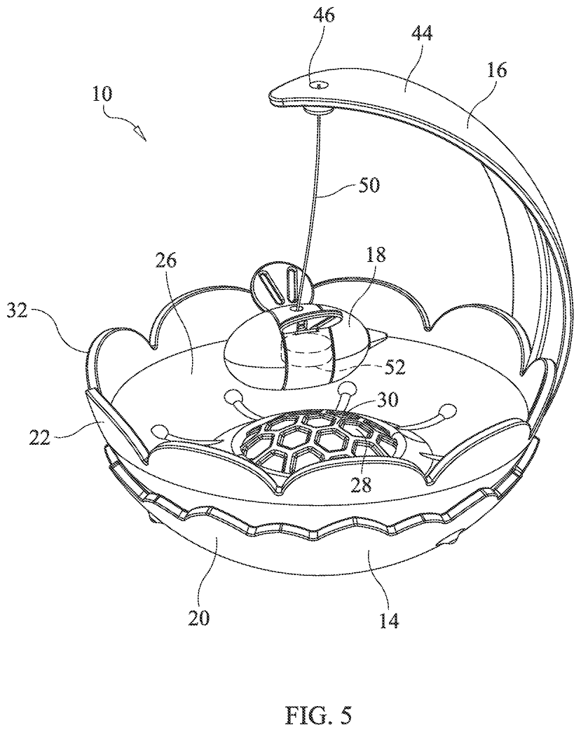

FIG. 6 is an exploded perspective view of the gyroscopic pet toy showing the base with a weight and a first magnet, the arm and the winged figure with a second magnet without the transparent sphere in accordance with the exemplary embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

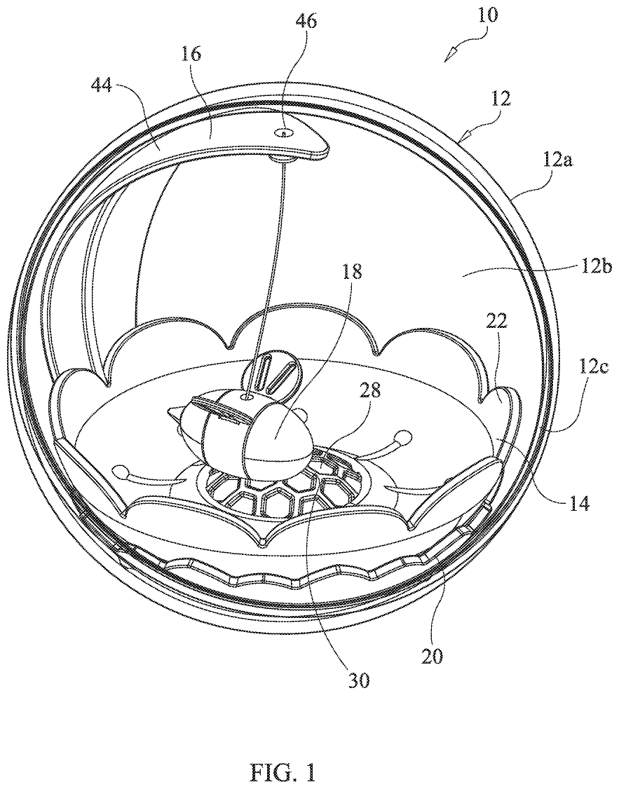

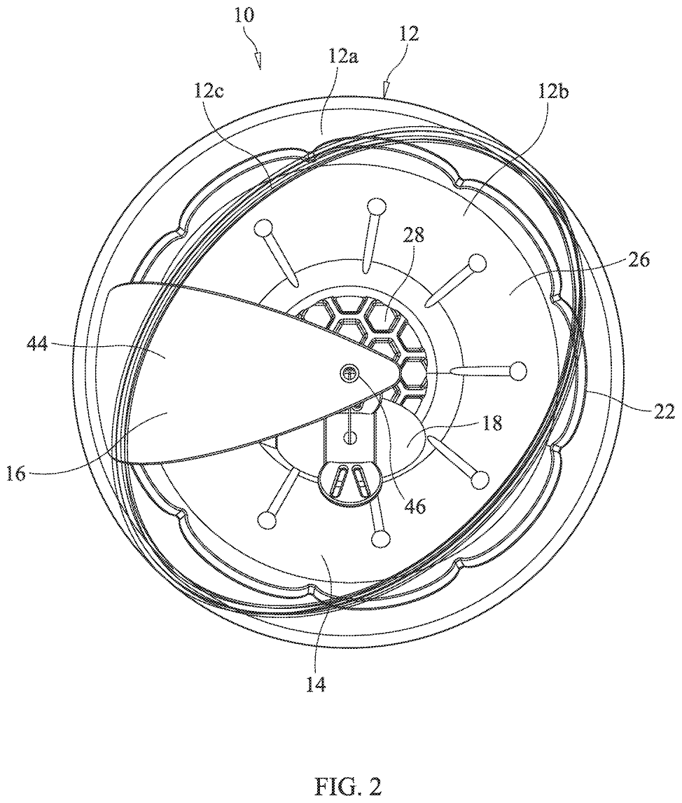

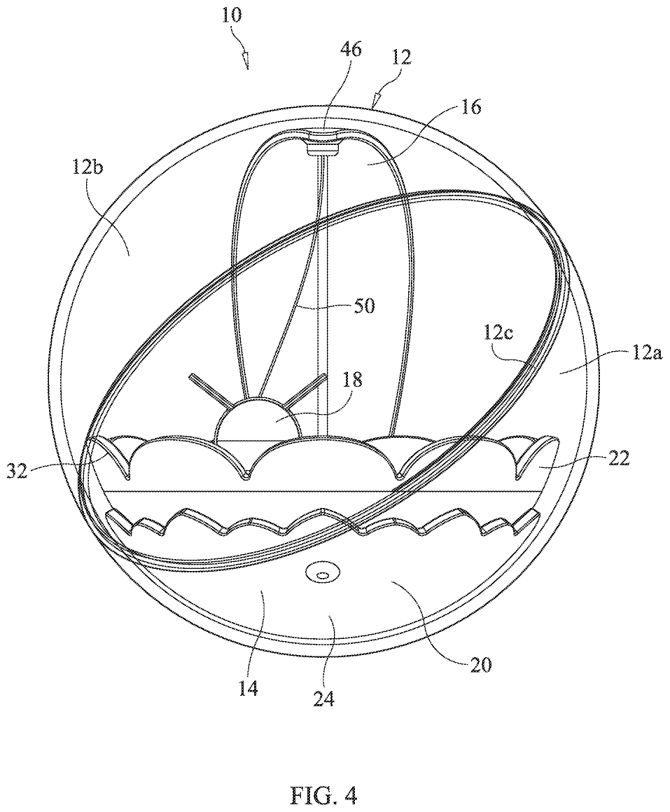

Referring initially to FIGS. 1-4, a gyroscopic pet toy 10 is illustrated in accordance with a first embodiment.

The gyroscopic pet toy 10 includes a hollow transparent sphere 12, a base member 14, an arm 16 and a winged FIG. 18 all disposed within the hollow transparent sphere 12.

The hollow transparent sphere 12 includes a first hemisphere 12a and a second hemisphere 12b that attached to one another at a seam portion 12c. The seam portion 12c can include a snap fitting structure where a reduced outer diameter edge of one of the first and second hemispheres 12a and 12b snap-fits into a larger inner diameter edge of the other of the first and second hemispheres 12a and 12b. However, prior to fitting the first and second hemispheres 12a and 12b together, the base member 14, the arm 16 and the winged FIG. 18 are assembled together and placed within the sphere 12.

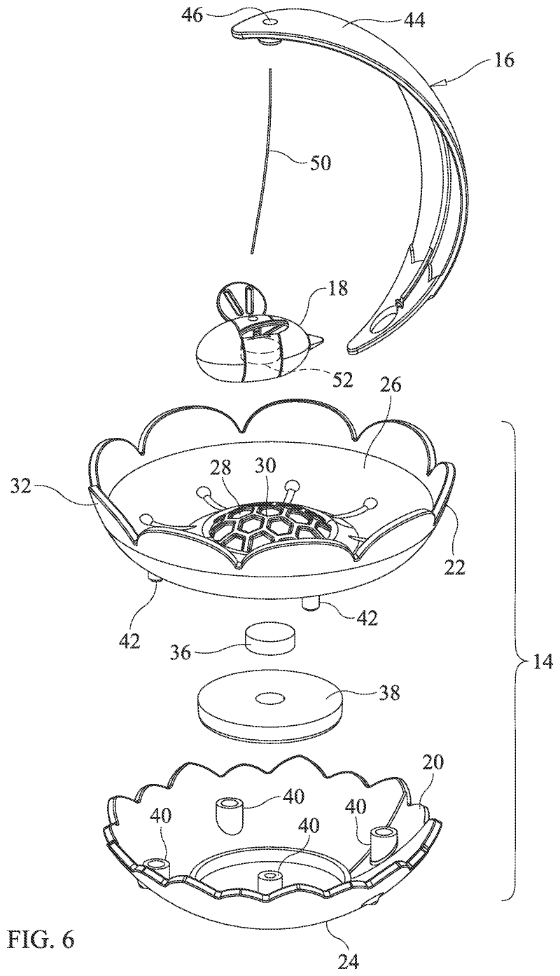

The base member 14 includes a lower member 20 and an upper member 22, as shown in FIG. 6. The lower member 20 has an overall spherically shaped lower surface 24 (less than half a hemisphere of a sphere). The upper member 22 has contoured upper surface 26 with decorative elements, such as a honeycomb-like contoured portion 28. The base member 14 also defines a central area 30 and an outer edge area 32.

A first magnet 36 is installed to the base member proximate the central area 30 between the lower member 20 and the upper member 22 along with a weight 38, as shown in FIG. 6. An upper surface of the lower member 20 includes first attachment structures 40 and a lower surface of the upper member 22 includes second attachment structures 42. The second attachment structures 42 have an outer diameter that is approximately equal to an inner diameter of the first attachment structures 40 such that the second attachment structures 42 can be inserted into the first attachment structures 40 and adhered to one another via, for example, snap-fitting protrusions (not shown) or an adhesive material. Alternatively, the first attachment structures 40 and the second attachment structures 42 can be fixed to one another with the upper via attachment members, such as, mechanical fasteners.

The lower member 20 has the partial spherical lower surface 24 that contacts an inner surface of the hollow transparent sphere 12. The outer diameter defined by the lower surface 24 of the lower member 20 is such that the lower member 20 slides easily around an inner surface of the hollow transparent sphere 12.

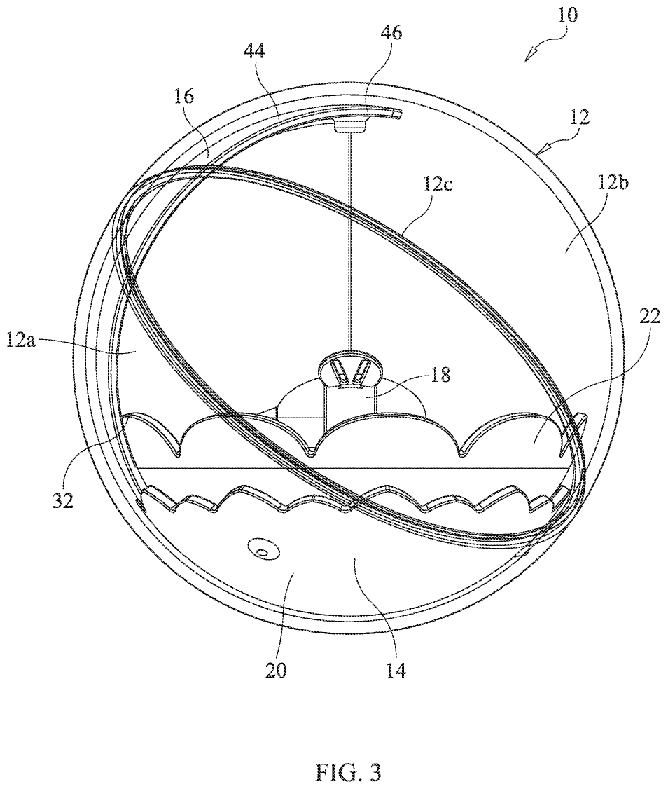

The arm 16 is attached to a lower surface of the upper member 22 of the base member 14 along an outer edge of the upper member 22, as shown in FIG. 3. The arm 16 has an arcuate shape that extends along the inner surface of the hollow transparent sphere 12 in a manner similar to the sliding contact between the lower surface 24 of the lower member 20 of the base member 14 and the inner surface of the hollow transparent sphere 12. More specifically, the arm 16 has a radially outer surface 44 having an arcuate, spherical shape that corresponds to the spherical shape of the lower surface 24 of the lower member 20 of the base member 14. Further, the lower surface 24 of the lower member 20 of the base member 14 and the radially outer surface 44 have a common center that preferably coincides with a center of the sphere 12.

Since the arm 16 has an overall arcuate shape, an extending upwardly distal end 46 of the arm 16 extends over the central area 30 of the base member 14.

The winged FIG. 18 preferably has an overall appearance of a bee with wings. Alternatively, the winged FIG. 18 can be a bird, butterfly or any of a variety of flying insects.

The winged FIG. 18 is suspended (hangs downwardly) from the distal end 46 of the arm 16 by a string-like element attached to the distal end 46 of the arm 16. The winged FIG. 18 is located above and spaced apart from the base member 14. The winged FIG. 18 has a second magnet 52 disposed therein. The first magnet 38 and the second magnet 52 are oriented to repel one another such that with the winged FIG. 18 is repelled by the first magnet 38 to move away from the central are 40 of the base member 14.

The string-like element 50 can be a stiff rod having an upper end attached to the distal end 46 of the arm 16 with freedom to pivot and swing relative to the arm 16. The winged FIG. 18 is rigidly fixed to a lower end of the string-like element 50. Alternatively, the string-like element 50 can be a very flexible fiber string that allows the winged FIG. 18 to move freely relative to the distal end 46 of the arm 16.

Alternatively, the winged FIG. 18 can be attached to a lower end of the stiff rod with freedom to pivot and swing relative to the stiff rod.

Since the base member 14, the arm 16 and winged FIG. 18 are not attached to the transparent plastic sphere 12, the base member 14, the arm 16 and winged FIG. 18 are free to undergo rotational movement within and relative to the transparent plastic sphere 12. However, the weight 38 being located within the base member 14 between the upper and lower members 20 and 22 urges the base member 14 to stay at the bottom of the sphere 12 due to gravity.

When the gyroscopic pet toy 10 is rolled on a flat surface, such as a floor, the base member 14, the arm 16 and winged FIG. 18 can remain in an upright orientation, as shown in FIGS. 1, 3 and 4, giving the appearance of a gyroscope. The effects provided by the inclusion of repelling magnets 36 and 52 on the winged FIG. 18 enhances the gyroscopic effects as the sphere 12 rolls along.

With the first and second magnets 36 and 52 oriented to repel one another, a pet can play with the gyroscopic pet toy 10 by, for example, pushing the toy along a floor surface. The weight 38 urges the base member 14 to stay proximate the lowest area of the sphere 12 as it rolls. Simultaneously, the momentum of the rolling of the sphere 12 causes the winged FIG. 18 move. The movement of the winged FIG. 18 can include random movements and erratic movements due and the repelling forces of the first and second magnets 36 and 52. A pet such as a cat will be further drawing drawn to the toy 10 upon observing these random and erratic movements, thereby enhancing animal play and increasing play time.

In the depicted embodiment, the first magnet 36 and the second magnet 52 are oriented to repel one another. Alternatively, the first magnet 36 and the second magnet 52 can be oriented to attract one another thereby limiting movement of the winged FIG. 18 when the sphere 12 rolls on a floor surface.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”. “having” and their derivatives. Also, the terms “part,” “section,” “portion,” “member” or “element” when used in the singular can have the dual meaning of a single part or a plurality of parts. Also as used herein to describe the above embodiment, the following directional terms “forward”, “rearward”, “above”, “downward”, “vertical”, “horizontal”, “below” and “transverse” as well as any other similar directional terms refer to those directions of a vehicle equipped with the gyroscopic pet toy. Accordingly, these terms, as utilized to describe the present invention should be interpreted relative to a vehicle equipped with the gyroscopic pet toy.

The terms of degree such as “substantially”, “about” and “approximately” as used herein mean a reasonable amount of deviation of the modified term such that the end result is not significantly changed

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A gyroscopic pet toy, comprising:
a base member having central area and an outer edge area;
a first magnet installed to the base member proximate the central area;
an arm attached to the base member proximate a portion of the outer edge area, the arm extending upwardly over the central area of the base member; and
a winged figure hanging downwardly from a string-like element attached to a distal end of the arm, the winged figure being located above and spaced apart from the central area of the base member, the winged figure having a second magnet disposed therein with the first and second magnets being oriented to interact with one another.

2. The gyroscopic pet toy according to claim 1, wherein
the winged figure is a bee.

3. The gyroscopic pet toy according to claim 1, wherein
the base member has a part spherical shape and the arm has an arcuate such that the base member and the arm have approximately the same center point.

4. The gyroscopic pet toy according to claim 1, wherein
the base member, arm and winged figure are disposed within a transparent plastic sphere.

5. The gyroscopic pet toy according to claim 4, wherein
the base member, arm and winged figure are not attached to the transparent plastic sphere such that the base member, arm and winged figure are free to undergo rotational movement within and relative to the transparent plastic sphere.

6. The gyroscopic pet toy according to claim 1, wherein
the string-like element is a stiff rod having an upper end attached to the distal end of the arm with freedom to pivot and swing relative to the arm.

7. The gyroscopic pet toy according to claim 6, wherein
the winged figure is attached to a lower end of the stiff rod with freedom to pivot and swing relative to the stiff rod.

8. The gyroscopic pet toy according to claim 6, wherein
the winged figure is non-movably attached to a lower end of the stiff rod.

9. The gyroscopic pet toy according to claim 6, wherein
the first and second magnets are oriented to repel one another.

10. The gyroscopic pet toy according to claim 6, wherein
the first and second magnets are oriented to attract one another.

11. A gyroscopic pet toy, comprising:
a hollow transparent sphere;
a base member within the hollow transparent sphere, the base member having a partial spherical lower surface contacting an inner surface of the hollow transparent sphere;
a first magnet attached to the base member;
an arm attached to an edge of the base member, the arm having an arcuate shape that extends along the inner surface of the hollow transparent sphere; and
a winged figure hanging downwardly from a string-like element attached to a distal end of the arm, the winged figure being located above and spaced apart from the base member, the winged figure having a second magnet disposed therein with the first and second magnets being oriented to interact with one another.

12. The gyroscopic pet toy according to claim 11, wherein
the first magnet installed to a central area of the base member.

13. The gyroscopic pet toy according to claim 11, wherein
the base member, arm and winged figure are not attached to the transparent plastic sphere such that the base member, arm and winged figure are free to undergo rotational movement within and relative to the transparent plastic sphere.

14. The gyroscopic pet toy according to claim 11, wherein
the winged figure is a bee.

15. The gyroscopic pet toy according to claim 11, wherein
the string-like element is a stiff rod having an upper end attached to the distal end of the arm with freedom to pivot and swing relative to the arm.

16. The gyroscopic pet toy according to claim 15, wherein
the winged figure is attached to a lower end of the stiff rod with freedom to pivot and swing relative to the stiff rod.

17. The gyroscopic pet toy according to claim 16, wherein
the winged figure is non-movably attached to a lower end of the stiff rod.

18. The gyroscopic pet toy according to claim 11, wherein
the first and second magnets are oriented to repel one another.

19. The gyroscopic pet toy according to claim 11, wherein
the first and second magnets are oriented to attract one another.
